(19) United States
(12) Patent Application Publication
(10) Pub. No.: US 2010/0037042 A1
(43) Pub. Date: Feb. 11, 2010

(54) SYSTEM FOR SWITCHING BIOS SET-VALUES

(75) Inventor: CHIH-MING KUO, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/238,397

(22) Filed: Sep. 25, 2008

(30) Foreign Application Priority Data
Aug. 8, 2008 (CN) 200810303632.X

(51) Int. Cl. G06F 15/177; G06F 12/02

(52) U.S. Cl. 713/2; 711/103

(57) ABSTRACT

An exemplary system for switching BIOS set-values includes a south bridge chip, a memory unit, a switching unit, and a BIOS chip. The south bridge chip is connected to the memory unit and the switching unit, and connected to the BIOS chip via a bus. The memory unit is configured for storing a plurality of groups of predetermined BIOS set-values. The switching unit controls the south bridge chip to selectively read a group of BIOS set-values from the memory unit, and then to write the group of BIOS set-values into the BIOS chip.

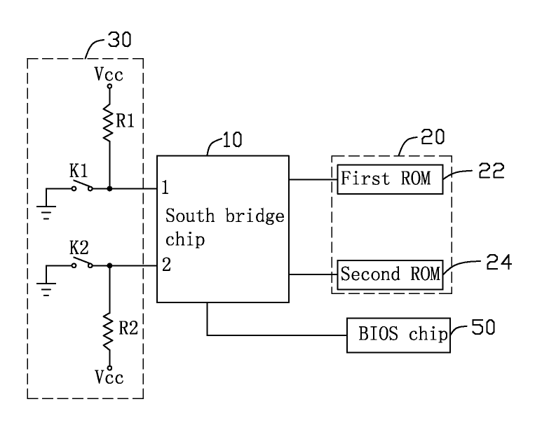

### BACKGROUND

1. Field of the Disclosure

The present disclosure relates to a system for switching basic input output system (BIOS) set-values.

2. Description of Related Art

A BIOS refers to firmware code run by a computer system when the computer system is first powered on. The BIOS can identify and initiate hardware components (such as hard disk drives, floppy disk drives, and optical disk drives), according to set-values in the BIOS. Thus, software programs stored on various media can be loaded and executed to control the computer system.

The BIOS set-values are stored in a memory that does not lose its stored contents when power to the computer system is cut off. Different BIOS set-values correspond to different tasks of the computer system, which means that the BIOS set-values should be changed to achieve optimum efficiencies when the computer system executes different tasks at a user's will. Therefore, existing configuration data will be overwritten, when the existing BIOS set-values containing boot options and configuration data for example need to be reset, which means that the configuration data must be reconstructed. Unfortunately, rebuilding of the configuration data may be a time-consuming process in which a user of the computer system may be prompted to manually select various options for purposes of rebuilding the configuration data.

What is needed is to provide a system for switching BIOS set-values easily and quickly.

### BRIEF DESCRIPTION OF THE DRAWING

The drawing is a circuit diagram of an embodiment of a system for switching BIOS set-values.

### DETAILED DESCRIPTION

Referring to the drawing, an embodiment of a system for switching BIOS set-values includes a south bridge chip 10, a memory unit 20, a switching unit 30, and a BIOS chip 50. The south bridge chip 10 is connected to the memory unit 20 and the switching unit 30, and connected to the BIOS chip 50 via a bus.

The memory unit 20 includes a first read only memory (ROM) 22 configured for storing a first group of BIOS set-values, and a second ROM 24 configured for storing a second group of BIOS set-values. The switching unit 30 includes a switch K1 associated with the first group of BIOS set-values, and a switch K2 associated with the second group of BIOS set-values. Each switch K1 and K2 includes two terminals. The first terminal of the switch K1 is connected to a first general purpose input output (GPIO) pin 1 of the south bridge chip 10, and to a power supply Vcc via a resistor R1, the second terminal of the switch K1 is grounded. The first terminal of the switch K2 is connected to a second GPIO pin 2 of the south bridge chip 10, and to the power supply Vcc via a resistor R2, the second terminal of the switch K2 is grounded.

The south bridge chip 10 stores a number of programs. The programs control the south bridge chip 10 to read a corresponding group of BIOS set-values from the memory unit 20 and to write them into the BIOS chip 50, according to open and closed states of the switches K1 and K2. For example, when the switch K1 is closed, the south bridge chip 10 detects that the voltage of the first GPIO pin 1 is at about 0 volts, and executes the program to read the first group of BIOS set-values from the first ROM 22, then to write the first group of BIOS set-values into the BIOS chip 50.

In one embodiment, setting and storing the BIOS set-values include the following steps. When a predetermined key, such as the “DEL” key of the keyboard, is pressed down during booting, the computer system executes its BIOS programs and jumps into a BIOS interface, and the first group of BIOS set-values, including boot options and configuration data, in the BIOS interface are set. The computer system writes the first group of BIOS set-values into the first ROM 22 via the south bridge chip 10, and the first group of BIOS set-values are stored in the first ROM 22. The second group of BIOS set-values, including boot options and configuration data, in the BIOS interface are set, after finishing setting and storing the first group of BIOS set-values. The computer system writes the second group of BIOS set-values into the second ROM 24 via the south bridge chip 10, and the second group of BIOS set-values are stored in the second ROM 24. The first ROM 22 and the second ROM 24 can be flash memories or electrically erasable programmable read only memories (EEPROMs). However, other memories having similar functions can also be used.

In use, a user can select one of the two groups of predetermined BIOS set-values to reset a computer system to satisfy specific needs, by closing the corresponding switch K1 or K2. For example, to use the first group of BIOS set-values, the user closes the switch K1. The south bridge chip 10 detects that the voltage of the first GPIO pin 1 is at 0 about volts, so it reads the first group of BIOS set-values from the first ROM 22 and writes the first group of BIOS set-values into the BIOS chip 50 to overwrite existing BIOS set-values in the BIOS chip 50. The south bridge chip 10 sends out a “RESET” signal to reboot the computer system, and the BIOS adopts the first group of BIOS set-values to reset the computer system. The memory unit 20 can store a plurality of groups of predetermined BIOS set-values, limited only by the number of ROMs and switches provided.

In another embodiment, the memory unit 20 has a ROM (not shown) replacing the first and second ROMs 22, 24, the ROM includes at least two storage areas configured for storing the first group of BIOS set-values and the second group of BIOS set-values. The memory unit 20 can store a plurality of groups of predetermined BIOS set-values, limited only by the number of storage areas the ROM is divided into and the number of switches provided.

It is to be understood, however, that even though numerous characteristics and advantages of the present disclosure have been set forth in the foregoing description, together with details of the structure and function of the present disclosure, the disclosure is illustrative only, and changes may be made in details, especially in matters of shape, size, and arrangement of parts within the principles of the present disclosure to the full extent indicated by the broad general meaning of the terms in which the appended claims are expressed.

What is claimed is:

1. A system for switching basic input output system (BIOS) set-values, comprising:
a south bridge chip comprising a plurality of general purpose input output (GPIO) pins;
a memory unit configured for storing a plurality of groups of predetermined BIOS set-values;
a BIOS chip; and
a switching unit configured for controlling the south bridge chip to selectively read a group of BIOS set-values from the memory unit according to voltage states of the plurality GPIO pins, and then to write the group of BIOS set-values into the BIOS chip.

2. The system as claimed in claim 1, wherein the switching unit comprises a plurality of switches corresponding to the plurality of groups of BIOS set-values, upon a condition that one of the switches is closed, wherein the south bridge chip reads a corresponding group of BIOS set-values from the memory unit, and then writes the corresponding group of BIOS set-values into the BIOS chip.

3. The system as claimed in claim 2, wherein each of the plurality of switches comprises a first terminal and a grounded second terminal, the first terminal is connected to a corresponding GPIO pin, and to a power supply via a resistor.

4. The system as claimed in claim 1, wherein the memory unit comprises a plurality of read only memories (ROMs) configured for storing the plurality of groups of BIOS set-values.

5. The system as claimed in claim 4, wherein the ROMs are flash memories.

6. The system as claimed in claim 4, wherein the ROMs are electrically erasable programmable read only memories.
